(19) United States
(12) Patent Application Publication
(10) Pub. No.: US 2017/0352040 A1
(43) Pub. Date: Dec. 7, 2017

(54) HEALTHY HANDS COOKING PLATFORM

(71) Applicant: Promo Trainers, LLC, Irmo, SC (US)

(72) Inventor: Janice Walker Pinnington, Irmo, SC (US)

(73) Assignee: Promo Trainers, LLC, Irmo, SC (US)

(21) Appl. No.: 15/613,320

(22) Filed: Jun. 5, 2017

Related U.S. Application Data
(60) Provisional application No. 62/345,020, filed on Jun. 3, 2016.

(51) Int. Cl. G06Q 30/02; G06Q 50/20; G09B 5/14; G09B 5/06; G06Q 30/00

(52) U.S. Cl. CPC G06Q 30/02; G06Q 50/205; G06Q 30/0253; G06Q 30/0277; G06Q 30/01; G09B 5/06; G09B 5/14

(57) ABSTRACT

An automated marketing and training regimen for certifying instructors and allowing same to create a microbusiness via a microsite and a technology software platform for implementing and supporting same.

### BACKGROUND OF THE INVENTION

### 1) Field of the Invention

The present invention relates to an automated marketing and training regimen for certifying cooking instructors and allowing instructors to create a microbusiness via a microsite and a technology software platform for implementing and supporting same.

### 2) Description of Related Art

The current disclosure seeks to remedy several existing problems in today's society as well as provide enhanced opportunities for interested individuals. For instance the current disclosure provides full time, part-time, and flexible opportunities to: stay-at-home moms by providing ways to generate income around the needs of their family; teachers looking to supplement their incomes; entrepreneurs looking to turn their passions into a career; grandparents looking to supplement their income with a skill they know; graduates looking to put their education and knowledge to use as a self-employed individual; working parents looking for ways to teach children and families skills because they do not have the time to do it themselves and Home Economics programs are no longer offered in schools; and healthy and unhealthy children and adults needing options and empowerment to make their own wholesome snacks and meals for themselves.

The health of our nations' children and adult population is currently at risk due to being overweight, obesity, or having unhealthy food addictions. More than 24.5 million U.S. children are now overweight or obese and $14.2 billion dollars is spent annually on direct medical costs to help these children. A child with one obese parent has a fifty percent chance of being obese. When both parents are obese, their children have an eighty percent chance of obesity. Many genetic and environmental factors contribute to the number of calories people eat and burn up, which is why weight loss and gain varies for different people. https://www.ucsfbenioffchildrens.org/conditions/obesity/

Accordingly, it is an object of the present invention to provide a portable, skill based program that can be tailored to children's and parents' needs and desires and a software platform for disseminating and operating same.

### SUMMARY OF THE INVENTION

In one embodiment, an electronic marketing and training regimen is offered. The regimen may comprise establishing an interactive electronic business platform, establishing eligibility criteria for at least one instructor, correlating eligibility criteria for the at least one instructor to determine if the at least one instructor is eligible, allowing an eligible instructor to create a customized microsite specific to that eligible instructor for operating a business via the electronic business platform, and generating, on a graphics display, a visualization of the microsite, such as a visual display of the instructor's customized microsite.

In a further embodiment, the microsite may be community-focused for the eligible instructor, such as via directing ads or other content to viewers of the microsite via geographic, zip code, or other location indicators relative to the instructor's location, such as their home address or business address. In another embodiment, the eligible instructor is granted temporary access to an instructor community. In a further embodiment, the eligible instructor is granted temporary access to a resource library. In a still further embodiment, the microsite may allow creation of a personalized business profile displayed via the graphics display. In another embodiment, the microsite allows modifications to an appearance and content of the interactive electronic business platform to suit the instructor's preferences. In another further embodiment, at least one third party user may interact with the microsite to conduct business. Still further, in order for the instructor to become eligible, the instructor must submit content via the interactive electronic business platform. Even further still, the content may be periodic submissions of an eligibility certification, such as a background check, sex offender registry check, cooking instruction test, safety test, etc., as described herein and known to those of skill in the art. Still further, the eligibility criteria may include passing a test. Even further yet, the test may be administered via the interactive electronic business platform.

In another embodiment, an interactive electronic business platform is provided. The platform may include establishing an interactive cooking instruction platform, establishing eligibility criteria for at least one cooking instructor, wherein the interactive cooking instruction platform correlates eligibility criteria for the at least one cooking instructor to determine if the at least one cooking instructor is eligible, allowing an eligible cooking instructor to create a customized microsite, which is specific to each eligible cooking instructor, for offering cooking classes or cooking products via the interactive cooking instruction platform, and generating, on a graphics display, a visualization of the microsite.

In a further embodiment, the microsite allows creation of a personalized business profile that may be displayed via a graphical interface. Still further, the instructor may modify appearance and content of the interactive cooking instruction platform. In a further embodiment, at least one third party user may interact with the microsite to purchase cooking classes or cooking products. In a yet further embodiment, for the instructor to become eligible, the instructor must submit content via the interactive cooking instruction platform. Still further, the content is periodic submissions of at least one eligibility certification. Even further, the eligibility criteria includes passing an instructor certification assessment such as a background check, sex offender registry check, cooking instruction test, safety test, etc., as described herein and known to those of skill in the art.

### BRIEF DESCRIPTION OF THE DRAWINGS

The construction designed to carry out the invention will hereinafter be described, together with other features thereof. The invention will be more readily understood from a reading of the following specification and by reference to the accompanying drawings forming a part thereof, wherein an example of the invention is shown and wherein:

FIG. 1 shows a schematic outline of a process for one embodiment of the current disclosure.

FIG. 2 shows a graphical display of one embodiment of a software platform used with the current disclosure.

FIG. 2B shows another graphical display of one embodiment of a software platform used with the current disclosure.

FIG. 2C shows yet another graphical display of one embodiment of a software platform used with the current disclosure.

FIG. 2D shows a further graphical display of one embodiment of a software platform used with the current disclosure.

FIG. 2E shows a still further graphical display of one embodiment of a software platform used with the current disclosure.

FIG. 2F shows another graphical display of one embodiment of a software platform used with the current disclosure.

FIG. 2G shows still another graphical display of one embodiment of a software platform used with the current disclosure.

FIG. 2H shows yet further graphical display of one embodiment of a software platform used with the current disclosure.

FIG. 3 shows an alternative embodiment of a software platform used with the current disclosure.

FIG. 4 illustrates one embodiment of the current disclosure showing communication between a microsite and platform of the current disclosure.

It will be understood by those skilled in the art that one or more aspects of this invention can meet certain objectives, while one or more other aspects can meet certain other objectives. Each objective may not apply equally, in all its respects, to every aspect of this invention. As such, the preceding objects can be viewed in the alternative with respect to any one aspect of this invention. These and other objects and features of the invention will become more fully apparent when the following detailed description is read in conjunction with the accompanying figures and examples. However, it is to be understood that both the foregoing summary of the invention and the following detailed description are of a preferred embodiment and not restrictive of the invention or other alternate embodiments of the invention. In particular, while the invention is described herein with reference to a number of specific embodiments, it will be appreciated that the description is illustrative of the invention and is not constructed as limiting of the invention. Various modifications and applications may occur to those who are skilled in the art, without departing from the spirit and the scope of the invention, as described by the appended claims. Likewise, other objects, features, benefits and advantages of the present invention will be apparent from this summary and certain embodiments described below, and will be readily apparent to those skilled in the art. Such objects, features, benefits and advantages will be apparent from the above in conjunction with the accompanying examples, data, figures and all reasonable inferences to be drawn therefrom, alone or with consideration of the references incorporated herein.

### DETAILED DESCRIPTION OF A PREFERRED EMBODIMENT

With reference to the drawings, the invention will now be described in more detail. Unless defined otherwise, all technical and scientific terms used herein have the same meaning as commonly understood to one of ordinary skill in the art to which the presently disclosed subject matter belongs. Although any methods, devices, and materials similar or equivalent to those described herein can be used in the practice or testing of the presently disclosed subject matter, representative methods, devices, and materials are herein described.

Unless specifically stated, terms and phrases used in this document, and variations thereof, unless otherwise expressly stated, should be construed as open ended as opposed to limiting. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

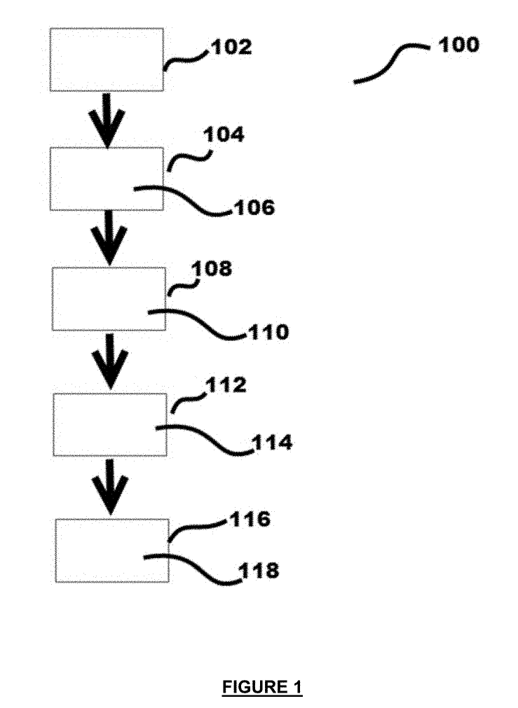

In one embodiment, the current disclosure provides a process for establishing a proprietary business. With respect to FIG. 1, process 100 may include, foremost, a background certification process 102, which serves as a gateway for instructors. Instructors not meeting the necessary background requirements, such as criminal record/sex offender record, work history, food handling safety training, certification testing, etc., as known to those of skill in the art, would not be allowed to progress further through the program. Once past the background certification process 102, an entrepreneur may be exposed to a business planning fundamentals module 104. This module may include receiving online or print materials 106 that help the instructor learn to write a proper business plan, assistance with filing for licensing and permits, setting up proper bookkeeping, obtaining liability insurance, and other necessary business requirements as known to those of skill in the art. Module 104 may also include an in-depth business and certification training component offered to save instructor time, frustration, and potential pitfalls of starting this type of business. At step 108, instructors may receive educational materials 110 such as pre-written lesson plans, nutrition activities, recipes, class scheduler, and marketing expertise. At step 112, an instructor may receive their own microsite 114, the microsite may include a web portal, access to a private internet site to run their own healthy cooking and other custom classes in the communities in which they live. Microsite 114 may serve as the instructor's connection to families in their community allowing interested customers to find and register their children for scheduled classes, camps and birthday parties simply by entering their zip code.

Further, unlike the main/marketing website, instructor microsites contain custom programmed software that is unavailable anywhere else on or offline. Through this unique platform, each instructor creates a personalized online business profile that they can then use to uniquely market and promote their individual educational classes based on their preference or style of teaching, such as, but not limited to: 1) working with various age groups (i.e. ages 2-5, 5-8, 9-13, 14+, 15-18, 19+ and active seniors); 2) styles of cooking, (i.e. vegan, vegetarian, traditional, etc.); 3) types of classes, (i.e. themed classes, cooking camps, birthday parties, college cooking, Girls Scouts Badges, etc.); 4) methods of food preparation (i.e. portable table top or full kitchen); 5) pricing (fee-based, non-profit, or combination of fee-based with discounts to serve their unique community's needs); or 6) custom classes of other disciplines that are complementary to their individual mission (i.e. yoga, etiquette, etc.

Using a menu selection from their microsite 114, instructors can check or uncheck a variety of options to customize their class offerings making this uniquely their own business concept. The variety of options provides a plethora of benefits to instructors including control over their own business and services, matching of personal food philosophies, customizable class recipes from a library of hundreds of options, competitive advantages by including the uniqueness of their own brand personality, and the ability to add complementary services or products to grow their revenue opportunities outside of provided class materials. This unprecedented platform technology allows for metamorphic accession and betterment of individual educational classes by providing unlimited diversity and customization to its member base, and infinite choices to parents and customers looking for instruction that match their interests, needs, and schedules.

Technically, each instructor microsite functions with an easy to employ user interface and dashboards with click and go, drag and drop, and upload/download capabilities and features. Although the user experience is designed to be easy and functional, the programming behind the scene is a highly scientific, specialized, and a mathematical encompassment that performs programmed algorithms, searching and matching functions, database management, process management, payment portal, business functions, class scheduling, detailed reporting, and more. No other software on the market today can perform these specialized functions as a complete package, or for this exclusive children and family healthy cooking industry.

At step 116, an instructor may become part of an instructor community 118. This may include features such as a private Facebook support group of other certified Instructors that collectively advise, encourage, guide and assist all instructors for ultimate success in each community they serve. In addition, instructors are invited to submit their own original healthy recipes that will be reviewed, approved, prepared, photographed and added to the instructor recipe library for sharing and distribution to other members in the community and used in future company classes. Instructors with published recipes receive online recognition through social media and shout outs, earn the title of HHC Contributing Editor, and are provided with active links back to their microsite as a way to generate more online traffic to their specific class offerings. Instructors in close geographic areas are introduced through the support community for collaborative opportunities within their communities such as attending events, tradeshows, and community based health fairs together, to bring awareness of their offerings to the community. The instructor support community provides a forum for sharing of new ideas. For example, the company recently created a specialized program for Girl Scouts of America (cooking badge training) that would not be tabled or shared without the support community and its collaborative mindset for the benefit of all its members.

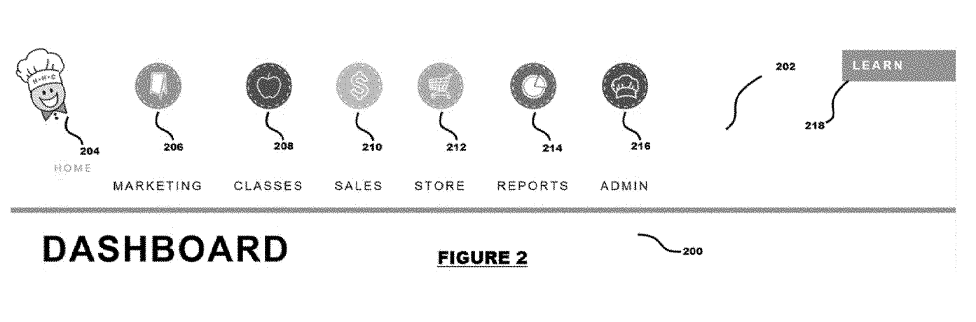

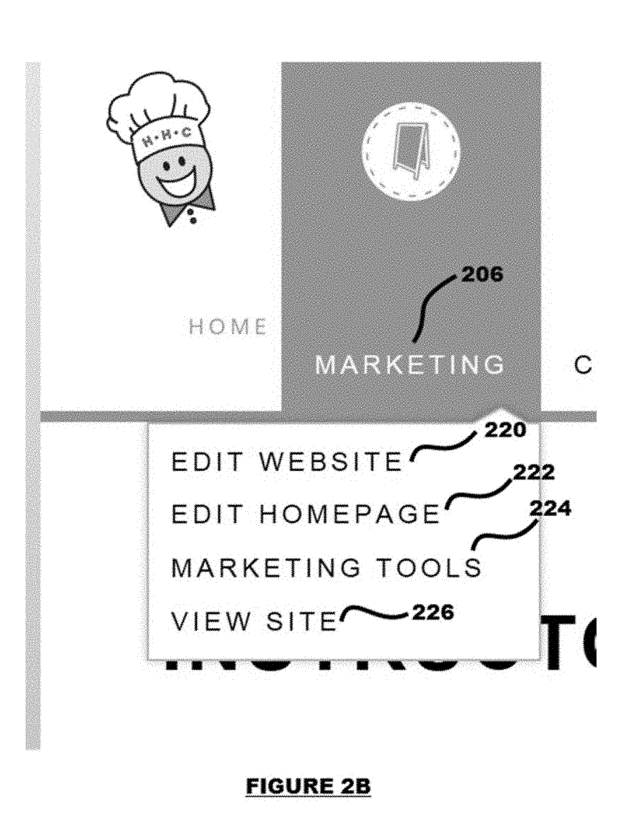

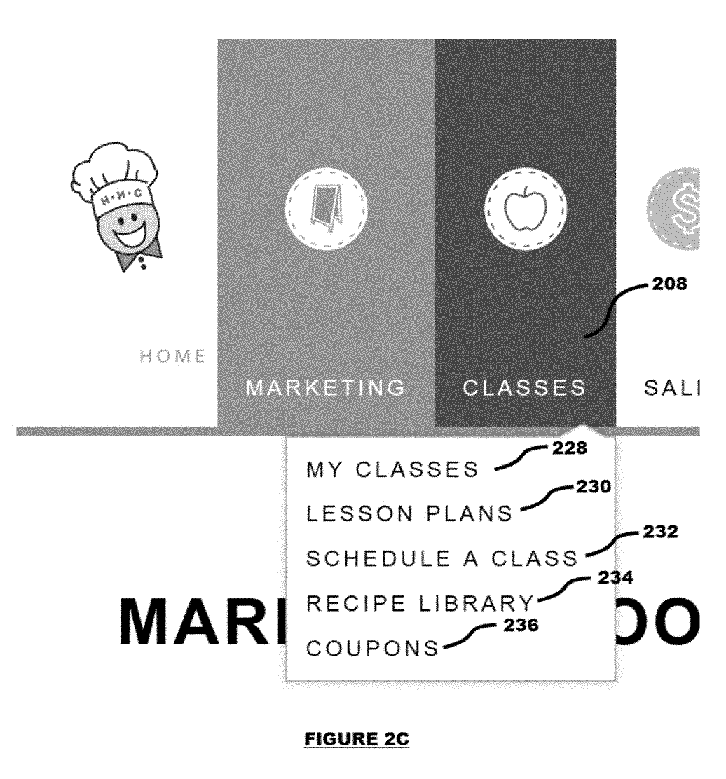

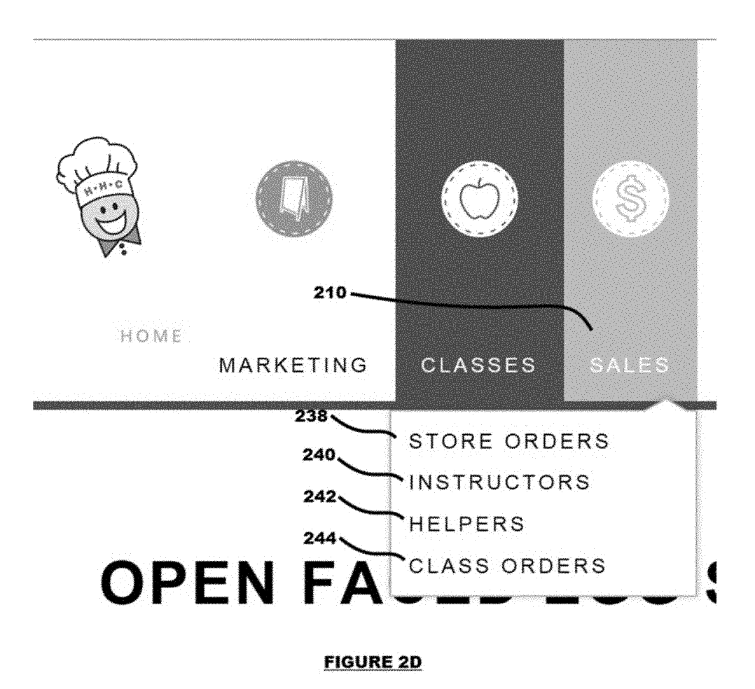

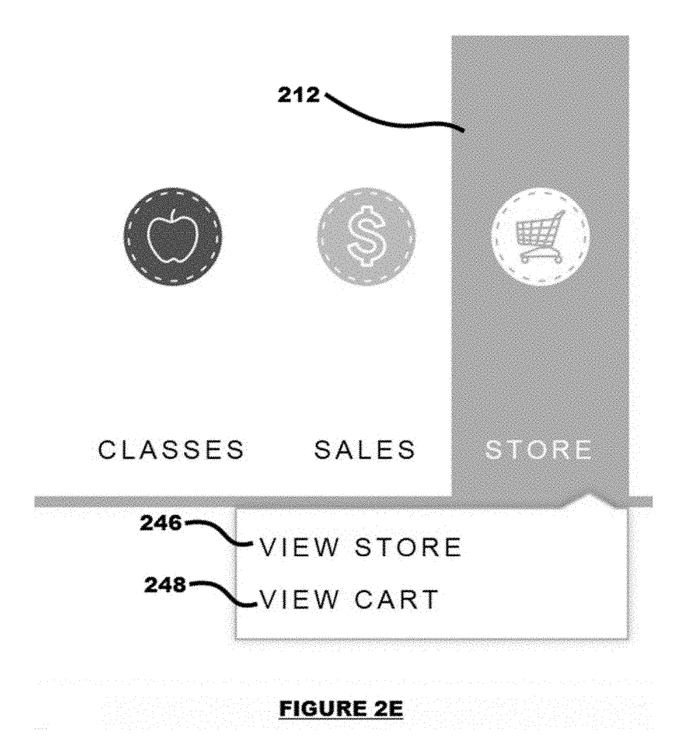

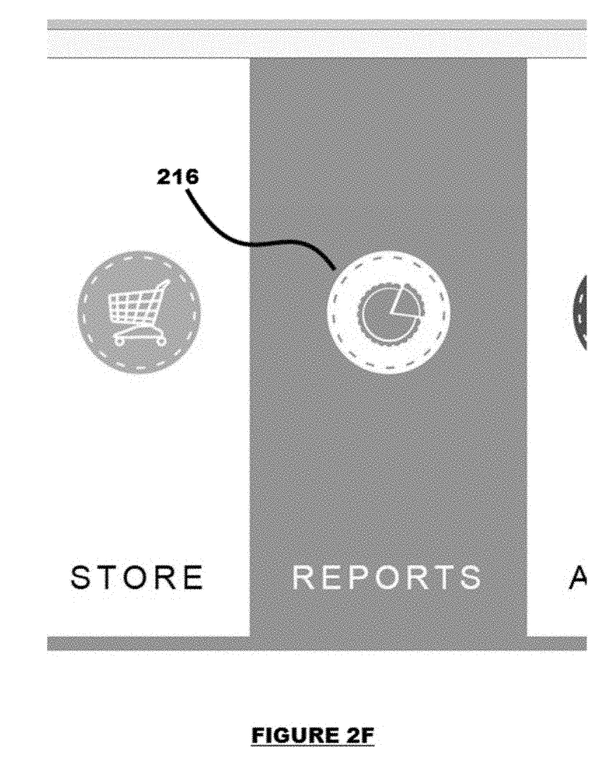

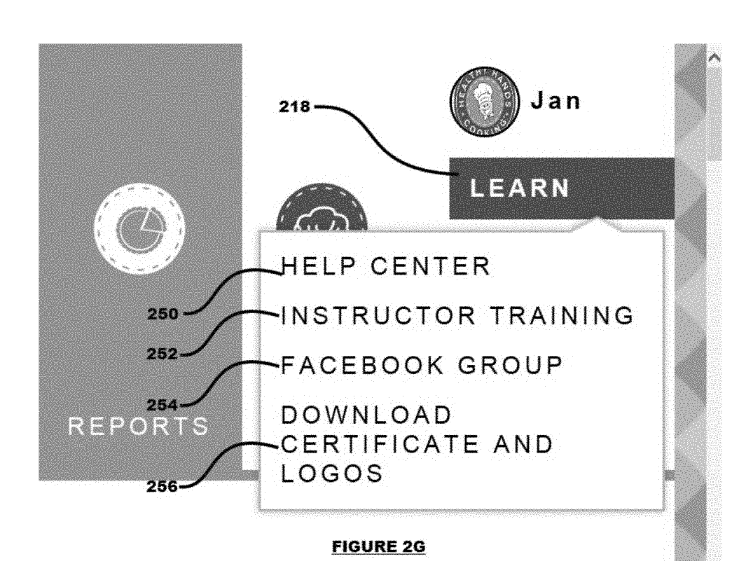

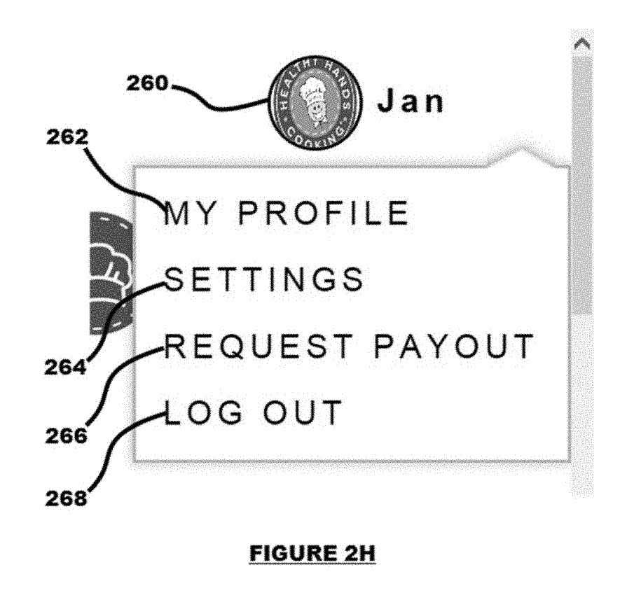

In a further embodiment, the current disclosure provides an interactive business/teaching assistance platform 200. Not all functionality herein described may be available to an instructor but may instead be limited to administrator access only. In one embodiment, see FIG. 2, platform 200 may provide a welcome screen 202 that may include navigation tabs such as Home 204, Marketing 206, Classes 208, Sales 210, Store 212, Reports 214, Administration 216, and Learn 218. Marketing tab 206 may include website editing tools 220 in order to edit/customize platform 200 via such methods as editing pictures, banner images, social media links, providing/editing links to external websites, as well as editing the categories of classes offered.

Marketing tab 206, see FIG. 2B, may also include an edit homepage tool 222 that allows a user to edit the user's homepage/microsite, which is the personalized portion of platform 200 that allows users to add their own biography, picture, social media links, outside links, schedule the instructor's classes, and collect payments. Marketing tab 206 may also include marketing tools 224, which may include annual conference training materials, affiliate program details, banners, birthday party tools, business cards, business templates, class calendar, college cooking tools, cooking camp tools, cooking for badges tools, coupons and discounts instructions, facility partnership tools, flyers, food allergies training, gift certificate templates, guest speaker resources, insurance options, legacy chefs tools, legal documents, logos, media/press kits, nutrition Canada, nutrition U.S. postcards, preschool tools, recommended pricing, social media images, support calls, videos (training and promo), and webinars., etc. Marketing tab 206 may also have a view site functionality 226 to exam changes made by the instructor to the microsite.

Classes tab 208, see FIG. 2C, may include My Classes 228, which details the types, times and sorts of classes and instructor is providing, Lesson Plans 230 that explain course coverage and preparation for teaching a cooking class, Schedule A Class function 232 that allows the instructor to customize the class being offered such as by determining the preferred audience, such as a birthday party, group of college students, etc., and/or by stating the type of kitchen needed for conducting the course, a user may also schedule a custom class that foregoes of platform 200 materials and creates a completely stand-alone class. Recipe Library 234 may also be included in classes tab 208. Recipe Library 234 may include meal plans for different meals, such as breakfast, lunch, or dinner, recipes based on age range of those in the class, type of foods such as desserts, casseroles, etc., special meals based on dietary restrictions or allergies, healthy snacks, etc. Classes tab 208 may also allow a user to create custom coupons for the classes in order to encourage attendance and/or gain new customers. A user may create custom coupon codes from 5% to 100% discount using perimeters such as number of total uses and/or expiration dates. Coupons can be applied by registrant on the public facing registration page of a user's custom microsite.

Recipe library 234 may allow users to access over 300+ custom created recipes by clicking on/off recipe criteria such as ingredient, age appropriateness, style of kitchen (portable vs traditional, allergens to avoid, type such as snack, breakfast, dessert, sides, soups, dips, appetizers, chicken, etc. Once a recipe is selected, user can print PDF of recipe for class handout. Class handouts automatically generate the instructor's name and contact information on each recipe. User has the ability to add a variation to the recipe (such replace dairy milk with almond milk) under the Variations tab. User may also enter notes into the Discussion tab to discuss this recipe with other instructors for advice and sharing.

My Classes 228 may include View Class or Duplicate class for repeat type classes. Under View Class, many more options open up to the user including the ability to print their lesson activity guide fully customized with their contact information and recipe selections from recipe library, the ability to email all participants in one keystroke regarding class offerings and details, access to the public facing link to quickly promote class(es) online, access to students tab that further drills down into details such as paid in full or balance owing, dietary restrictions, dietary allergies, name, age, sign up date, and actions of registrant, downloadable class report, accident and model release waivers captured and the ability to add students to classes. Also included is the ability to cancel a class due to low enrollment or special circumstance, and search for students using designated search box. Under Duplicate Class, user may duplicate exact same class materials and recipes saving time or choose new recipes for same class nutrition theme by dragging and dropping primary recipes to the right, and dragging unused recipes to the left to make them primary for the next class. Classes and Recipes 212 may offer proprietary materials available only through platform 200. For example, “Schedule a Class” tabs guide a user through the selection of class themes (such as “Have A Souper Day”—homemade soup class). Once a theme is selected, the user can then access the nutrition lesson plan and select recipes from primary and secondary recipes that correspond to the theme by dragging and dropping into place. Once a user is satisfied with their recipe selection, they enter the class details into the next section of the online process including title, class category, class description, price, visibility (public or private), number of students (minimum/maximum), age range, location, date of class or sessions, registration expiration, and payment method (either collect payment online through microsite or direct customer to alternative payment method such as an alternative registration portal (i.e. school registration) or other methods such as cash, check, PayPal, virtual terminal, or other. All class materials include, “how to” guidance on teachings sessions that can also be used for other events such as health fairs, hosting cooking events, cooking demonstrations, educational presentations for schools, and additional venues which may be directed at particular national or ethnic preferences. Once “Schedule A Class” has been created, the platform simultaneously pulls the nutrition lesson plan with the user's custom selected recipes and systematically compiles a PDF of the class curriculum, inserting the instructor's name and contact information on the cover sheet of the class handout. User may enter the class theme's “Discussions” tab to converse with other instructors about their experience teaching this class such as “This class was fun! We had time to make baked croutons to put in our soup”. The discussions tab is a private forum for instructors to comment and engage to help each other run efficient and effective classes.

Sales tab 210, see FIG. 2D, may include functionalities for store orders 238, that show classes, materials, or supplies that have been purchased via platform 200. Sales tab 210 may also include information on instructors 240, such as their current status on the site, contact information, renewal dates, their number of class attendees, etc. Information on helpers 242, those who assist the instructors, may also be accessed via the sales tab 210. Sales tab 210 may also include class order information 244 showing what classes have been purchased by what instructors. For example, Class Orders #1—Users have access to a sales tab that allows user to see a summary of each class held, name of student, date of enrollment, class fee paid, payment type, order status (paid, open, refunded) and can be further filtered by timeframe including All Time, This Week, Last Week, This Month, Last Month, This Year, Last Year. Class orders can be downloaded into a CSV file for user needs. In another example, Cass Order #2 allows users to view details of each customer order including name, age, fee, payment, current balance, type of payment, refunds, class type, add cash payment, add refund, show discount coupon, amount, contact information including name, email, phone, notes, and update order feature.

Store tab 212, see FIG. 2E, may include view store 246 which enables one to access the various support materials available to instructors as well as view cart 248 which shows which items have currently been selected for purchase by instructors.

Reports tab 214, see FIG. 2F, enables a user to see revenue based on various periods, sales by category, helper sales, certification sales, subscription sales, store sales, etc. A user may select and download class revenue by gross amount, total refunds, total fees, net revenue, total amount paid, average revenue per attendee, and average revenue per month further categorized by Revenue by Day, Revenue by Month, Revenue by Week and Revenue by Year. Reports may also be filtered by All Time, All Class Types and All States. Administration tab 216 allows one to see a list of orders, with look up capabilities, business metrics, global messaging to all users via the website content, members, store overview, support features such as open tickets or Help Center access, class overview, and a marketing tools overview.

Learn tab 218, see FIG. 2G, includes Help Center Module 250, Instructor Training Module 252, Social Media Module 254, and Certificate and Logo module 256. Help Center Module 250 may include inquiry platform that enable an instructor to ask questions, submit a request for assistance, or search prior Help Center Module 250 content. Instructor Training Module 252 may include an extensive training session that may be used to certify an instructor under the Healthy Hands program. Training resources may include a business section for helping instructors understand how to form a business, a guide to forming a plan to build a cooking business, food and safety handling materials, which may further require an instructor to take, pass, and provide evidence of passing via platform 200 a food handler course in order for an instructor to become certified. The course may be approved by a federal or state agency. Instructor Training Module 252 may further include media plan resources for helping an instructor form a media plan in order to announce and promote their business, guides for marketing strategies as well as information on how to select and promote a business to a specified demographic, class and student kits, including instructor manuals and children's workbooks as well as the ability to order kits that include the basic cooking accoutrements for teaching a cooking class.

Instructor Training Module 252 may also include recipe and nutrition information, information on growing a cooking education business, forum and support information for informing instructors how to work with one another, access to an instructor community for communication and interaction with other instructors, a resource for recruiting “helpers” to assist an instructor with instruction as well as to register and ensure the helper is fully certified to per HHC guidelines, including a background check of the helper and requiring the helper to pass training and a certification test in order to be approved as a helper. Training Module 252 may also contain a test for the instructor and helper to take. In order to become certified, all instructors and helpers must take the test and make a passing score in order to receive certification via platform 200.

Learn tab 218 may also provide links to HHC social media that are otherwise unavailable to third parties. For instance, a Facebook community may be accessed through Learn tab 218. Additionally, Learn tab 218 may provide a certificate and logo resource 256 that allows certified instructors and/or helpers to download various certificates and materials from platform 200.

Platform 200 may also include profile functionality 260, see FIG. 2H. Profile functionality 260 may include My Profile module 262, Setting module 264, Request Payout module 266 and Log Out module 268. My Profile module 262 allows an instructor to personalize platform 200 to form/enhance microsite 114 by adding the instructor's personal information such as name, address, birthday, contact information, etc. Settings module 264 allows an instructor to add certified helpers, check on account status, close their account, see the number of students currently enrolled, cash available, cash pending, receipts, as well as the ability to report any issues with platform 200. Settings module 264 also allows an instructor to “pause” their account by hiding the site from third party searches until the instructor wishes to begin or continue teaching courses. Setting module 264 may also include mass mail capabilities, such as a MAILCHIMP, for contacting students, soliciting new customers, etc. Request Payout module 266 may enable an instructor to create a payment portal, such as by associating a payment method with their account, such as a credit card, debit card, bank account, etc. Request Payout module 266 may be used to not only pay for the services offered via platform 200 but also for collecting amounts from class attendees for the user and directing same to where the instructor wishes the payments to be made. Log Out module 268 allows the user to terminate their session on platform 200.

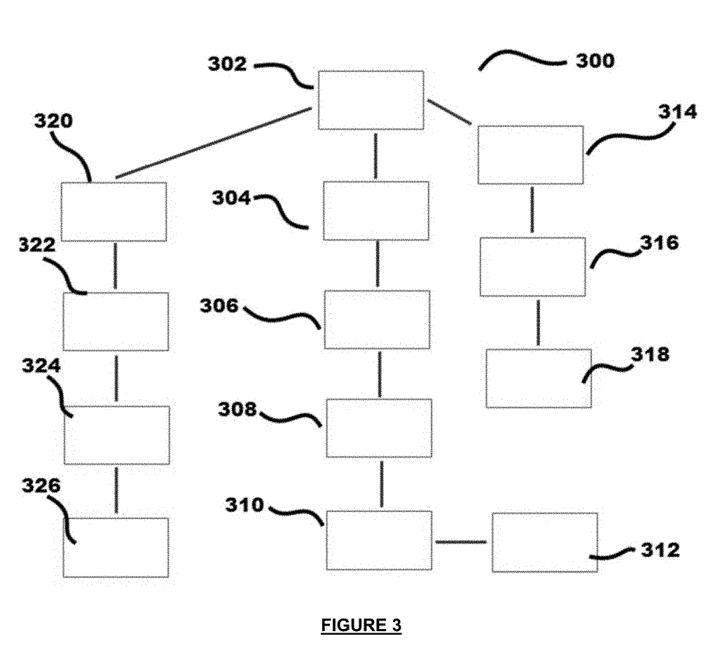

Access to the platform of the current disclosure may be restricted to only current users based on preferred criteria, such as guest status, payment of annual renewal fees, maintaining qualifications, and/or other factors deemed necessary for maintaining user status. In a further embodiment, see FIG. 3, platform 300 may include a personalized instructor website 302, class scheduler 304 for listing instructor classes, online registration function 306, a capture module 308 for obtaining and preserving legal forms required from parents on behalf of the instructor via the automated student registration process. Platform 300 will also include a listing module 310 that integrates personalized instructor website 302 with a main events calendar 312 for users seeking classes in the instructor's geographic area. Platform 300 may also include downloadable tools module 314 which may include lesson plans, nutrition activities, healthy recipes, and downloadable class tools. In addition, platform 300 may include editable marketing materials module 316 which may contain items such as business cards, postcards, flyers, banners, and logos. Instructor store module 318 may be found in platform 300 as well and include instructor kits, workbooks and kitchen tools. Live marketing support calls module 320 may provide prerecorded calls that are uploaded to for the user's use. For example, support module 322 may provide users with email and FB (Facebook) messaging support to quickly answer any questions regarding any step of the process from partial interest to full implementation. A Zen Help Desk software program may be added to the site for responding and tracking parent and instructor queries. Cases will be assigned to trained support personnel to answer questions in a timely manner; with the goal being same day response but no longer than a 24-hour timeframe. Additional support methods include theme-based webinar training, instructional video training, and community blog/conversation ability. New materials module 324 may provide regularly updated new class material. Business support module 326 may provide the user with business templates and agreements.

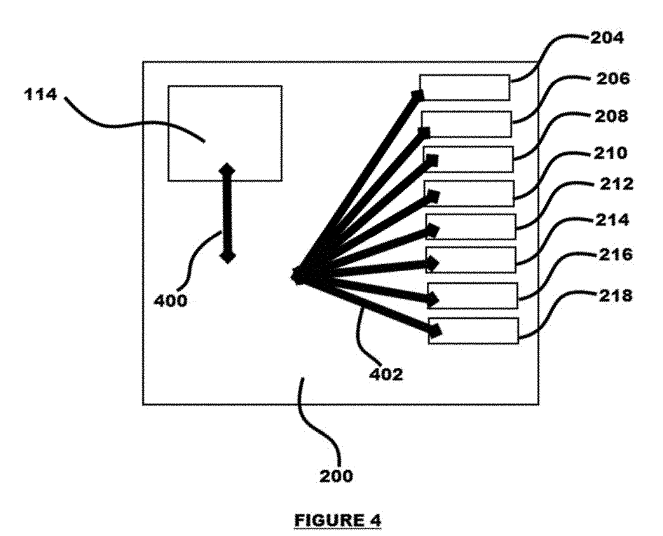

FIG. 4 illustrates one embodiment of the current invention showing communication between microsite 114 and platform 200. To help conceptualize the invention, in one aspect, microsite 114 portrays the publicly seen view of an instructor's “version” of platform 200 achieved after the instructor personalizes microsite 114 via the functionality supplied via platform 200, such as personalizing microsite 114 with the instructor's images, bio, choice in background, class offerings, etc., and making this available via a monitor, graphic interface, etc., as known to those of skill in the art. Imagine platform 200 as a fairground cut out depicting a scene with an opening for a person's head. Microsite 114 acts as the person's head appearing in the hole in the fairground cut out while platform 200 provides the “background” imagery essential to allow microsite 114 to function. In this way, microsite 114 has limited two way interaction 400 with platform 200, and via platform 200 limited interaction with aspects of resources 204, 206, 208, 210, 210, 212, 214, 216, and 218 as described supra. Meanwhile, platform 200 has full two way interaction 402 with all aspects of resources 204, 206, 208, 210, 210, 212, 214, 216, and 218 as described supra.

In a further embodiment, a business model may be established using the above described customized and interconnected platforms. For instance, a unique custom written certified cooking instructor training may be created that is not available in any other format. The certification training may uniquely combine custom written and specialized business modules in the field of children's and adult cooking certification instruction and includes, but is not limited to, proper licensing for food related services, specialized permits and regulations, facility set-up and maintenance, for-profit and non-profit consultation, criminal and sex offender background checks, food handling safety, food allergy guidance, legal guidance, marketing consultation, media training, bookkeeping basics, liability insurance consultation, cooking class instruction, culinary safety, effectively working with children, proper food preparation/storage and testing. One such example is DII Certified Instructor Training. DII stands for Dietary Inflammation Index and is a patented process exclusively licensed to CHI (Connecting Health Innovations). CHI is currently finalizing an agreement for a 5-year renewable contract with HHC (the platform providers) to train new DII Certified Instructors exclusively through the Healthy Hands Cooking Platform because of its unique ability to capture, track and customize the experience for each user.

The business model may further include age appropriate nutrition lesson plans and single serving healthy recipes with portability. Although the internet, book stores, and magazine racks are full of family cooking recipes and menu plans, the current disclosure provides a specialized approach that has never existed under one umbrella. Specifically, each lesson plan should meet the following criteria to serve the customer base:

1. Nutrition game or activity, age appropriate, to set the stage for learning and act as the introduction to the cooking part of our class;

2. Single serving recipes that have been created, tested, photographed and published so that each child has a hands-on experience with fun, tasty foods and increased retention of the skill;

3. Portability—recipes are created so that all instructors can teach regardless of whether they have access to a full kitchen or just portable appliances like pancake griddles, toasters, and blenders;

4. Instructional take home sheets—so that students can re-create their class experience at home and begin preparing meals for their families;

5. Following the model's food protocol, recipes must be made using whole foods with no artificial ingredients, sweeteners, additives, or colors; and

6. Lesson plans and recipes must be downloadable, printable, and customizable so that each instructor can add their own contact information to handouts.

The business model may also provide a Class Scheduler, Database Management, and Payment Portal Software Platform. To date, these platforms have not existed as needed by the current disclosure. The software used with the current disclosure is programmed to include intricate searching/matching algorithms in geographic areas to match parents with instructors, database management that contains a master database and uniquely separate databases for each individual instructor, email and social media software that connects each instructor to his/her specific community/region, payment portal for parents registering their children for classes, and class schedulers with auto-fill functions, pricing options, and data search capabilities.

The business model may also include an Instructor Personalized Website. Although many website platforms are available for free such as Weebly, Joomla, WordPress and others, many potential instructors are either unfamiliar with building their own website, or are technically challenged to do so. The current disclosure provides a solution for the customer base via developing a custom website template that is easily and quickly personalized by each instructor.

With a few simple clicks, instructors can add their picture, add a biography, add affiliate links, upload images, add videos, and then link directly to their social media accounts. In addition, the custom class scheduler pulls current class data and immediately posts it to the instructor's website so that all current classes are showing on their websites along with class descriptions, pricing, and registration options for parents. As an added bonus, instructors with their own companies can upload their personal logo and co-brand their instructor website with that of the current disclosure making this a truly one-of-a-kind kids cooking website. This personalized website option was not previously available to instructors nor available to the degree of personalization provided by the current disclosure.

The business model may further include a Recipe Search, Types of Classes, and a Style of Teaching Software Platform. The current disclosure is compatible with instructors from across the U.S., Canada and over-seas that have a variety of cooking philosophies, styles, and techniques. In order to accommodate the wide range of instructor and parent needs, the current disclosure provides a custom software piece that helps an instructor to set up their unique class offering by simply clicking or un-clicking options in their back office. For example, some instructors prefer to teach younger kids while some prefer to teach older kids. With a click of a button, they can choose to offer classes to ages 2-5, 5-8, 9-13, and 14+. Additional choices include selecting your teaching style such as traditional cooking, vegetarian, vegan, gluten-free, among others. Further options include teaching theme-based classes, cooking camps, birthday parties, or senior community classes. Lastly, the current disclosure provides extensive recipe search programmed software that allows instructors to pull recipes from various lesson plans and databases that form part of the current disclosure to make their classes uniquely their own. HEALTHY HANDS COOKING MARKETING SITE—Prospective Instructors and Customers find the Healthy Hands Cooking Marketing Site through a variety of online methods including social media, mom bloggers, affiliate marketers, business partners, SEO, funnel marketing and other means. When a visitor lands on the home page, they are directed in one of 4 ways: 1. Become An Instructor, 2. Find an Instructor, 3. Blog/Recipes and 4. Affiliate Login. Instructor Prospects choose “Become An Instructor” where they will be led through a series of tabs education them on our mission, certification, membership, pricing, testimonies and FAQ. Registrant Prospects choose “Find An Instructor” where they can enter their zip code or postal code and find all HHC Certified Instructors within 50 miles of their address, or, they can search on name of instructor. Any Visitor can click on Blog/Recipes to get fun healthy recipes and HHC News. Prospects interested in referring Healthy Hands Cooking Instructor Career Opportunity to their lists or followers will click on the Affiliates tab to learn more about earning a commission for their referral.

In one embodiment, platform 200, or any other embodiment of a platform disclosed herein, may employ a variety of software packages in conjunction with custom developed functionality. This may include a typical LAMP stack, including Linux, apache, MySQL and PHP. The PHP framework may be a Symfony version 2.8. This provides a model-view-controller architecture upon which to structure platform data. Symfony may include a Doctrine PHP package which abstracts interactions with the database by automatically building MySQL queries. The views may be compiled through the Smarty PHP template engine, version 3.1. Smarty allows one to quickly build syntactically complex logical flows. To generate PDF documents, platform 200 may employ the wkhtmltopdf package, along with custom developed functionality to combine the PDF's into a single document. This allows one to upload recipes individually and build a class based on any combination of recipes available in the database. During use, a user may select the recipes they wish to use and the backend system will automatically create a customized PDF for them to distribute to users.

Emails via platform 200 may be sent using Amazon's Simple Email Service (SES) in order to maintain high deliverability without putting a strain on application services. For the frontend of the site, Foundation, jQuery and ParsleyJS may be employed. Foundation allows one to quickly lay out various elements in a grid. jQuery permits various data handling actions as a library for JavaScript; ParsleyJS is instrumental in form validation. Comments on recipes and classes may be enabled through the Disqus comment engine. Additionally, WYSIWYG editors may be used throughout platform 200 and may use the TinyMCE plugin to generate HTML code, which is then escaped (for security) and displayed to the user via a graphics display, such as a monitor or other means known to those of skill in the art.

Instructor store module 318 may be built as a custom PHP store. It may allow visitors to view products, choose a product, and purchase that product. Payments may be handled using Stripe's token system to ensure consistent security.

Schedule A Class function 232 may be built as a custom PHP script to allow instructors to choose the time, date(s), capacity, price, lesson plan, location and age. The instructor-training center is a custom built PHP script which displays information from a TinyMCE editor and allows the user to read and download documents. At the end, the test is created by simply comparing each answer to an array of correct answers by posting the data to the server. From there, the system determines if the test-taker has passed or failed.

In a further embodiment, when a customer signs up to become a Healthy Hands Cooking Certified instructor they are presented with a license agreement and membership agreement. Those may be stored on a server for later retrieval if needed. The license agreement may be electronically signed one once the Certification package is purchased and can be accessed by the site admin under the instructors account.

When a new instructor initiates their training, she may be asked to complete a background check as well as a food safety certification. The food safety certification prompt may be found is found in Training Module 252. The food safety certificate may be uploaded to the instructors account and may be located by the site administrator, by viewing the instructors account. A background check may also be completed by the instructor through a prompt in training module 252. Once the background check is complete it may be uploaded and stored for later access by the site admin as well by viewing the instructors account. This same course may be followed for Certified Helpers as well as well as Insurance Certificates for each instructor.

Instructors may be given extreme flexibility to create coupons by choosing the percentage, number of uses, expiration date, and coupon code. This is a custom feature of the platforms discussed herein and allows instructors to adjust the price paid by their customers on an individual basis.

Further, when a customer signs up for an Instructor's Class they may be asked to agree to the a Terms and Conditions document. This form may be found on any instructor Healthy Hands Cooking website where a HHC Class is being offered. These waivers may be saved for each customer, on a server or in memory, that registers for a HHC Class any may be available on a server when/if needed.

The platforms of the current disclosure may also generate a wide variety of administrative reports for instructors/administrators using the platforms. For instance, Administrative Reports may be generated. These reports may be generated via accessing Sales Tab 210 and may include, but are not limited to, Sales by Category, Certification Sales (sales for training package), Membership/Subscription Sales (sales for use of materials and website), Helper Sales (certified Helpers added to HHC Instructor Accounts), Store Sales (additional supplies and merchandise purchased by instructors), HHC Fees (fees for using the site and stripe to collect class payment), E-Book Sales (for Marketing Business Builder E-book), Core Sales (sales made through Click Funnels Marketing Funnel). Further, all categories may be displayed by Day, Week, Month or Year. Further, each categories may have its own section of reporting as well vs looking at all categories at once. For purposes of example only, types of reports may include Physical Product Sales, which may be found under Sales Tab 210, which may generate a report differentiating Physical Products Sales from Training and Membership Sales. These, too, may be viewed by Day, Week, Month, Year. Further, order numbers may be displayed to allow an administrator to “drill down” to item specifics. These may also be shown by Day, Week, Month or Year. In another example, HHC Fees Sales, which may also be accessed under Sales Tab 210, may show Total Fees Collected for Instructor Use of the HHC+Payment Portal. This report may show HHC Revenue from Collected Fees as well as display Day, Week, Month or Year numbers. In a still further example, an All Sales report may be generated, also via access under Sales Tab 210, that shows all Sales regardless of category, this also may be displayed by Day, Week, Month or Year.

Further, one of the most important administrative functions allows the administrator to “masquerade” as an instructor, to see their information and execute commands on their behalf. This was built using a custom PHP script, which for administrators converts their user ID temporarily over to the user ID of the user in need of assistance.

Finally, user accounts are feature-limited based on their payment “tier”. This is accomplished through custom code written to compare the instructor's “tier” to a table of different tiers, and enabling various features based on their permission level. As a result, we can effectively offer multiple versions of the same product.

While the present subject matter has been described in detail with respect to specific exemplary embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art using the teachings disclosed herein.

What is claimed is:

1. An electronic marketing and training regimen comprising:
establishing an interactive electronic business platform;
establishing eligibility criteria for at least one instructor, wherein the interactive business platform correlates eligibility criteria for the at least one instructor to determine if the at least one instructor is eligible;
allowing an eligible instructor to create a customized microsite specific to that eligible instructor for operating a business via the electronic business platform; and
generating, on a graphics display, a visualization of the microsite.

2. The electronic marketing and training regimen of claim 1, wherein the microsite is community-focused for the eligible instructor.

3. The electronic marketing and training regimen of claim 1, wherein the eligible instructor is granted temporary access to an instructor community.

4. The electronic marketing and training regimen of claim 1, wherein the eligible instructor is granted temporary access to a resource library.

5. The electronic marketing and training regimen of claim 1, wherein the microsite allows creation of a personalized business profile displayed via the graphics display.

6. The electronic marketing and training regimen of claim 1, wherein the microsite allows modifications to an appearance and content of the interactive electronic business platform.

7. The electronic marketing and training regimen of claim 1, wherein interactive electronic business platform allows at least one third party user to interact with the microsite to conduct business.

8. The electronic marketing and training regimen of claim 1, wherein in order for the instructor to become eligible, the instructor must submit content via the interactive electronic business platform.

9. The electronic marketing and training regimen of claim 8, wherein the content is periodic submissions of an eligibility certification.

10. The electronic marketing and training regimen of claim 1, wherein the eligibility criteria includes passing a test.

11. The electronic marketing and training regimen of claim 10, wherein the test is administered via the interactive electronic business platform.

12. An interactive electronic business platform comprising:
an interactive cooking instruction platform;
establishing eligibility criteria for at least one cooking instructor, wherein the interactive cooking instruction platform correlates eligibility criteria for the at least one cooking instructor to determine if the at least one cooking instructor is eligible;
allowing an eligible cooking instructor to create a customized microsite, which is specific to each eligible cooking instructor, for offering cooking classes or cooking products via the interactive cooking instruction platform; and
generating, on a graphics display, a visualization of the microsite.

13. The electronic marketing and training regimen of claim 12, wherein the microsite allows creation of a personalized business profile displayed via the graphics display.

14. The electronic marketing and training regimen of claim 12, wherein the microsite allows modifications to an appearance and content of the interactive cooking instruction platform.

15. The electronic marketing and training regimen of claim 12, wherein the interactive electronic business platform allows at least one third party user to interact with the microsite to purchase cooking classes or cooking products.

16. The electronic marketing and training regimen of claim 12, wherein in order for the instructor to become eligible, the instructor must submit content via the interactive cooking instruction platform.

17. The electronic marketing and training regimen of claim 16, wherein the content is periodic submissions of at least one eligibility certification.

18. The electronic marketing and training regimen of claim 12, wherein the eligibility criteria includes passing an instructor certification assessment.
